(19) United States
(12) Patent Application Publication
(10) Pub. No.: US 2011/0211634 A1
(43) Pub. Date: Sep. 1, 2011

(54) Method and apparatus for offset metadata insertion in multi-view coded view

(76) Inventors: Richard Edwin Goedeken, Santa Clarita, CA (US); Joan Llach, Cesson-Sevigne Cedex (FR)

(21) Appl. No.: 12/932,169

(22) Filed: Feb. 18, 2011

Related U.S. Application Data
(60) Provisional application No. 61/306,855, filed on Feb. 22, 2010.

(51) Int. Cl. H04N 7/24; H04N 7/26

(52) U.S. Cl. 375/240.02; 375/E07.005; 375/E07.126

(57) ABSTRACT

A method and apparatus are disclosed and described for providing Offset Metadata insertion in multi-view coded video. The apparatus includes an offset metadata inserter (235) for receiving a first bitstream compressed using a single-view based two-dimensional video compression scheme, a second bitstream compressed using a multi-view based two-dimensional video compression scheme, and disparity information, and outputting a third bitstream based on the first bitstream, the second bitstream, and the disparity information. Each of the first bitstream, the second bitstream, and the disparity information correspond to a same video sequence. The third bitstream includes group of pictures information extracted from the first bitstream and underlying content of the video sequence at least some of which is extracted from the second bitstream. The third bitstream has embedded therein one or more messages that specify the disparity information for use in overlaying information on the underlying content of the video sequence during a subsequent displaying of the overlaying information on the underlying content.

### CROSS-REFERENCE TO RELATED APPLICATIONS

This application claims the benefit of U.S. Provisional Application Ser. No. 61/306,855, filed Feb. 22, 2010, which is incorporated by reference herein in its entirety.

### TECHNICAL FIELD

The present principles relate generally to video encoding and, more particularly, to a method and apparatus for offset metadata insertion in multi-view coded video.

### BACKGROUND

The SONY BLU-RAY disc standard (also known as BD or simply BLU-RAY) has recently been extended to support new three-dimensional (3D) video capabilities. The previous two-dimensional (2D) BLU-RAY standard allowed the following several different video compression formats to be used: the International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard” or simply the “AVC Standard”); the Society of Motion Picture and Television Engineers (SMPTE) Video Codec-1 (VC-1) Standard; and the ISO/IEC MPEG-2 Standard. However, the only video compression format allowed by the new BLU-RAY 3D standard is an extension of the MPEG-4 AVC Standard called MVC (Multi-View Coding).

One of the problems introduced by the new 3D video experience for home theaters is related to overlay graphics generated by the BLU-RAY disc player. This player needs to present graphics and text to the viewer overlaid on top of the video at certain times. The problem introduced by these overlay graphics is that in order for the graphics to “look right” and not be objectionable to the viewer, they must be presented at a certain 3D depth location (which is implemented as a disparity or offset between the left eye image and right eye image) which is determined by the depth of the objects in the underlying video.

However, there are currently no known methods or algorithms which the player can use to automatically determine the correct depth at which to present the overlay graphics, so the proper depth values must be determined by a human during the video production process and then embedded into the video stream itself in such a way that the BLU-RAY player can read these values and render the overlay graphics with the desired disparity.

The BLU-RAY 3D standard includes a propriety data structure called Offset Metadata (or Offset Metadata messages) which includes these disparity values for the overlay graphics. These Offset Metadata messages include one or more disparity values for each frame in the video sequence, and they are embedded in the compressed video (MVC) bitstream.

The most obvious way to implement the Offset Metadata insertion task is to add it directly to the encoder, which is responsible for initially generating the compressed MVC bitstream. However, this solution has a disadvantage in that any time the video production team wishes to change part of the Offset Metadata (which is not uncommon, given the realities of the video production business), the video production team must re-run the encoding process, which is a very computationally expensive (time-consuming) task.

### SUMMARY

These and other drawbacks and disadvantages of the prior art are addressed by the present principles, which are directed to a method and apparatus for offset metadata insertion in multi-view coded video.

According to an aspect of the present principles, there is provided an apparatus. The apparatus includes an offset metadata inserter for receiving a first bitstream compressed using a single-view based two-dimensional video compression scheme, a second bitstream compressed using a multi-view based two-dimensional video compression scheme, and disparity information, and outputting a third bitstream based on the first bitstream, the second bitstream, and the disparity information. Each of the first bitstream, the second bitstream, and the disparity information correspond to a same video sequence. The third bitstream includes group of pictures information extracted from the first bitstream and underlying content of the video sequence at least some of which is extracted from the second bitstream. The third bitstream has embedded therein one or more messages that specify the disparity information for use in overlaying information on the underlying content of the video sequence during a subsequent displaying of the overlaying information on the underlying content.

According to another aspect of the present principles, there is provided, in an apparatus having a processor, a method performed by the processor. The method includes receiving a first bitstream compressed using a single-view based two-dimensional video compression scheme, a second bitstream compressed using a multi-view based two-dimensional video compression scheme, and disparity information. The method further includes outputting a third bitstream based on the first bitstream, the second bitstream, and the disparity information. Each of the first bitstream, the second bitstream, and the disparity information correspond to a same video sequence. The third bitstream includes group of pictures information extracted from the first bitstream and underlying content of the video sequence at least some of which is extracted from the second bitstream. The third bitstream has embedded therein one or more messages that specify the disparity information for use in overlaying information on the underlying content of the video sequence during a subsequent displaying of the overlaying information on the underlying content.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram showing an exemplary multi-view video encoder, in accordance with an embodiment of the present principles;

FIG. 2 is a high level block diagram showing an exemplary Offset Metadata inserter, in accordance with an embodiment of the present principles; and

FIG. 3 is a flow diagram showing an exemplary method for offset metadata insertion in multi-view coded video, in accordance with an embodiment of the present principles.

### DETAILED DESCRIPTION

The present principles are directed to a method and apparatus for offset metadata insertion in multi-view coded video.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “1”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Moreover, as used herein, the words “same video sequence” refer to an input sequence of pictures that is common to a plurality of input bitstreams used by the present principles to provide an output (MVC) bitstream having Offset Metadata inserted therein. That is, the same input sequence of pictures may be encoded, for example, using the MPEG-4 AVC Standard to obtain an input AVC bitstream and also encoded, for example, using the MVC extension of the MPEG-4 AVC Standard to obtain an input MVC bitstream. The input AVC bitstream and the input MVC bitstream, along with disparity information, may be encoded, for example, using the previous BLU-RAY Standard (also referred to here as the “BLU-RAY two-dimensional standard) or the aforementioned new BLU-RAY 3D Standard (or some other 3D video encoding standard or recommendation), to obtain an output MVC bitstream having video content therein. In one or more embodiments, such video content may be displayed and/or otherwise reproduced as three-dimensional (3D) video content. In such a case, the input AVC bitstream may be used to encode, for example, the left (or right) eye view of the 3D video content, while the input MVC bitstream may be used to encode, for example, the right (of left) eye view of the 3D video content. It is to be appreciated that in an embodiment of the present principles, the left eye view of the 3D video content is also used as a backward-compatible two-dimensional (2D) video stream for older BLU-RAY players. In any cases where it matters in what format the pictures are captured/initially encoded/etc. with before any encoding, for example, in accordance with any of the aforementioned video compression standards, then the “same video sequence” may refer to the actual content from which such pictures would be derived.

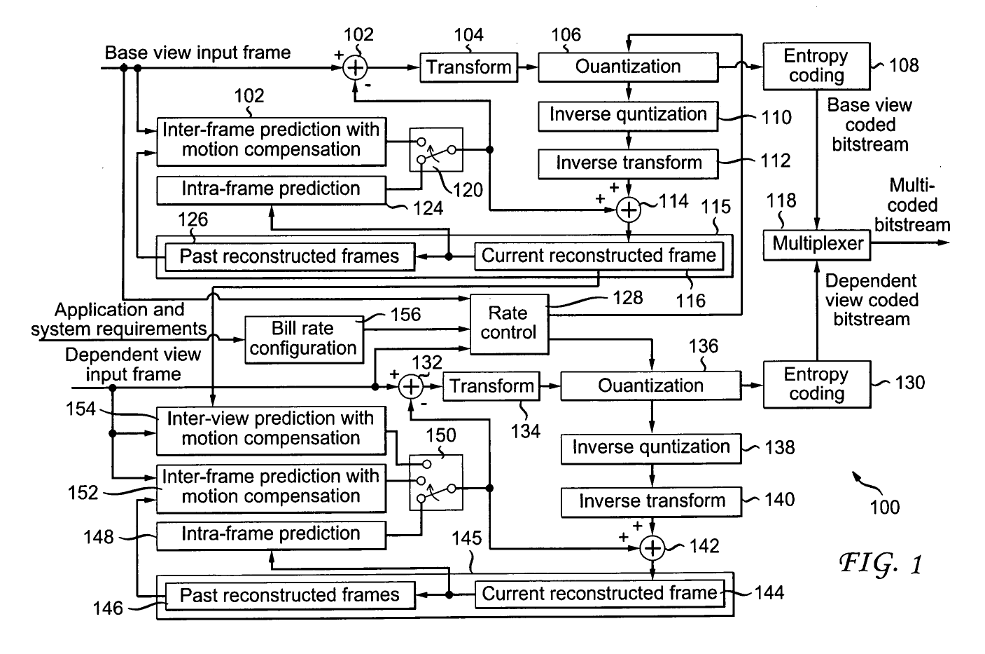

Further, as used herein, the phrase “underlying content of a video sequence” refers to the video data that is representative of the input sequence of pictures, such as chroma and luma data, and which is ultimately displayed to a user in some form (e.g., as single-view video data or multi-view video data or three-dimensional multi-view video data, of course after some processing/formatting of such data for display purposes). Turning to FIG. 1, an exemplary multi-view video encoder is indicated generally by the reference numeral 100. The video encoder 100 includes a combiner 102 having an output connected in signal communication with an input of a transformer 104. An output of the transformer 104 is connected in signal communication with a first input of a quantizer 106. A first output of the quantizer 106 is connected in signal communication with an input of an inverse quantizer 110. An output of the inverse quantizer 112 is connected in signal communication with an input of an inverse transformer 112. An output of the inverse transformer 112 is connected in signal communication with a first non-inverting input of a combiner 114. An output of the combiner 114 is connected in signal communication with an input of a buffer 115. The buffer 115 stores a current reconstructed frame 116 output from the combiner 114 as well as past reconstructed frames 126 previously output from the combiner 114. A first output of the buffer 115 is connected in signal communication with an input of an intra-frame predictor 124. A second output of the buffer 115 is connected in signal communication with a first input of an inter-frame predictor with motion compensation 122. An output of the intra-frame predictor 126 is connected in signal communication with a first input of a switch 120. An output of the inter-frame predictor with motion compensation 122 is connected in signal communication with a second input of the switch 120. An output of the switch 120 is connected in signal communication with an inverting input of the combiner 102 and a second non-inverting input of the combiner 114. A second output of the quantizer 106 is connected in signal communication with an input of an entropy coder 108. An output of the entropy coder 108 is connected in signal communication with a first input of a multiplexer 118.

An output of a bit rate configurer 156 is connected in signal communication with a first input of a rate controller 128. A first output of the bit rate configure 156 is connected in signal communication with a second input of the quantizer 106. A second output of the rate controller 128 is connected in signal communication with a first input of a quantizer 136. A first output of the quantizer 136 is connected in signal communication with an input of an entropy coder 130. An output of the entropy coder 130 is connected in signal communication with a second input of the multiplexer 118. A second output of the quantizer 136 is connected in signal communication with an input of an inverse quantizer 138. An output of the inverse quantizer 138 is connected in signal communication with an input of an inverse transformer 140. An output of the inverse transformer 140 is connected in signal communication with a first non-inverting input of a combiner 142. An output of the combiner 142 is connected in signal communication with an input of a buffer 145. A first output of the buffer 145 is connected in signal communication with an input of an intra-frame predictor 148. An output of the intra-frame predictor 148 is connected in signal communication with a first input of a switch 150. A second output of the buffer 145 is connected in signal communication with a first input of an inter-frame predictor with motion compensation 152. An output of the inter-frame predictor with motion compensation 152 is connected in signal communication with a second input of the switch 150. A third output of the buffer 115 is connected in signal communication with a first input of an inter-view predictor with motion compensation 154. An output of the inter-view predictor with motion compensation 154 is connected in signal communication with a third input of the switch 150. An output of the switch 150 is connected in signal communication with an inverting input of a combiner 132 and a second non-inverting input of the combiner 142. An output of the combiner 132 is connected in signal communication with an input of a transformer 134. An output of the transformer 134 is connected in signal communication with an input of a quantizer 136.

A non-inverting input of the combiner 102, a second input of the inter-frame predictor with motion compensation 122, and a second input of the rate controller 128 are available as inputs of the MVC video encoder 100, for receiving a base view input frame. An input of the bit rate configure is available as an input of the MVC video encoder 100, for receiving application and system requirements. A third input of the rate controller 128, a non-inverting input of the combiner 132, a second input of the inter-view predictor with motion compensation 154, and a second input of the inter-view predictor with motion compensation 152 are available as inputs of the MVC encoder 100, for receiving a dependent view input frame. An output of the multiplexer 118 is available as an output of the MVC encoder 100, for outputting a multi-view coded bitstream.

It is to be appreciated that an MVC encoder such as, for example, the MVC encoder 100 of FIG. 1, may be used to generate an MVC bitstream. Such an MVC bitstream, along with other information as described below, may be provided as an input to an Offset Metadata inserter in accordance with an embodiment of the present principles. Such an Offset Metadata inserter is configured as a post-processor to the encoding process in order to obviate the need to re-encode an input bitstream for the sole purpose of simply inserting the Offset Metadata.

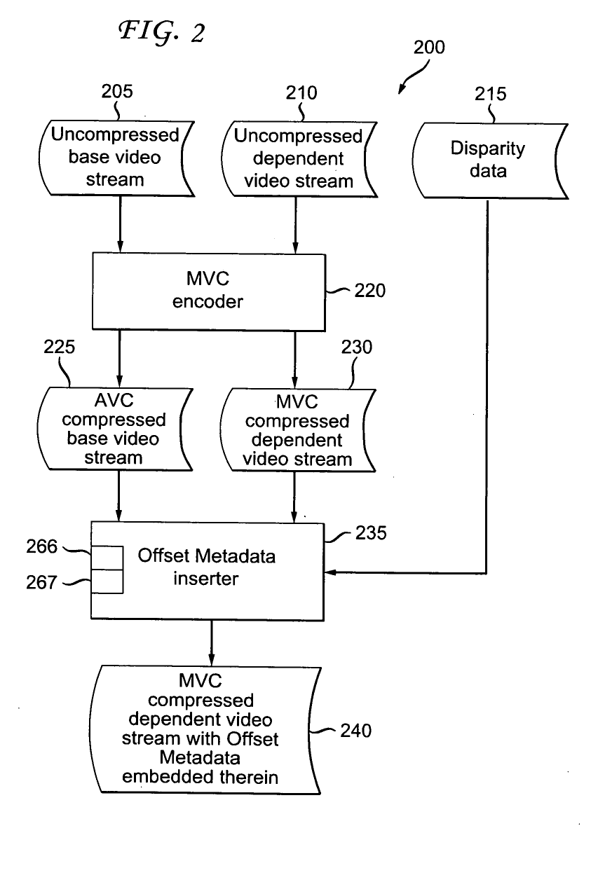

Turning to FIG. 2, an exemplary Offset Metadata inserter and corresponding operating environment are indicated generally by the reference numeral 200. The Offset Metadata inserter is indicated particularly by the reference numeral 235. An MVC encoder 220 receives an uncompressed base video stream 205 and an uncompressed dependent video stream 210, and outputs an AVC compressed base video stream 225 and an MVC compressed dependent video stream 230. The AVC compressed base video stream 225 and the MVC compressed dependent video stream 230, as well as disparity data 215, are input to an Offset Metadata inserter 235. An MVC compressed dependent video stream with Offset Metadata embedded therein is output from the Offset Metadata inserter 235.

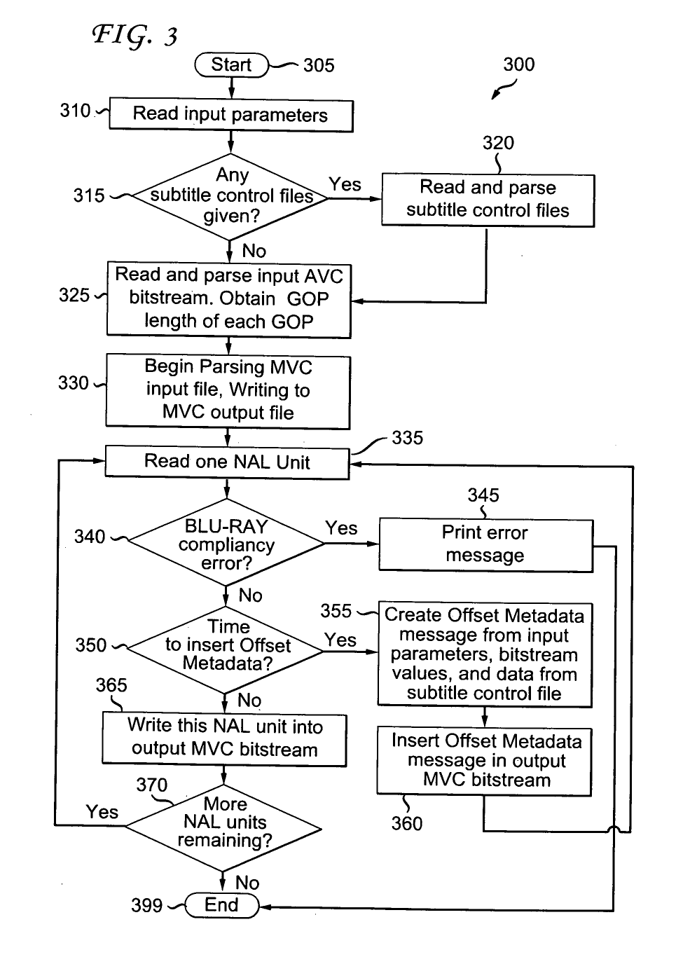

It is to be appreciated that one or more elements of the Offset metadata inserter 235 may include one or more respective processors and memory therein and/or may share one or more processors and memory there between. In the particular embodiment of FIG. 2, a processor(s) 266 and memory (267) are shared between the elements of the Offset Metadata inserter 235. Such processor(s) 266 may be used to, for example, perform the method 300 described herein below with respect to FIG. 3. Moreover, while not explicitly shown, one or more processors and attendant memory may also reside in one or more elements of the encoder 100 and/or may be shared there between. The same applies to MVC encoder 220.

Further, it is to be appreciated that while the Offset Metadata inserter 235 is shown in FIG. 2 as a standalone device independent from an encoder, in other embodiments of the present principles, the Offset Metadata inserter 235 may be included within and as part of an encoder. Given the teachings of the present principles provided herein, one of ordinary skill in this and related arts will contemplate these and other variations regarding implementations of the present principles, while maintaining the spirit of the present principles.

As noted above, the present principles are directed to a method and apparatus for offset metadata insertion in multi-view coded video. In accordance with the present principles, special messages (called Offset Metadata) are inserted into the compressed video bitstream after encoding has been completed. The offset metadata includes 3D depth information for overlay text and graphics. Some examples of such overlay graphics include, but are not limited to: subtitles; play/stop/forward/reverse icons; menus; and video stream information.

In accordance with an embodiment of the present principles, an Offset Metadata inserter accepts the following three inputs: an AVC bitstream (which encodes the left eye of the 3D video, which is also used as a backward-compatible 2D video stream for older Blu-Ray players); an MVC bitstream (which encodes the right eye of the 3D video); and some information which includes the disparity values to use for overlay graphics of each frame of the video sequence. The method and apparatus of the present principles provide one output, which is an MVC bitstream that includes the embedded Offset Metadata messages. The method and apparatus of the present principles provide at least the following two useful functions: first, some verification and checking are performed to ensure that the AVC and MVC bitstreams belong together and are properly compliant with the BLU-RAY disc specifications and have not been corrupted during the video production process. Secondly, the input disparity values (which have been generated with human input and may be in one of several different formats, including a special format generated by a subtitling tool used in a different video product department) are read, and the BLU-RAY Offset Metadata messages are created and embedded into the MVC bitstream in a manner which is compliant with the BLU-RAY disc specification.

Regarding the aforementioned verification process, it is to be appreciated that such process is optional, but preferable, in order to pre-assure compliance of the MVC stream output from the Offset Metadata inserter 235 with, for example, the BLU-RAY 3D standard. In such a case when the verification process is performed, the Offset Metadata inserter 235 determines the picture type for each picture in the AVC stream. Specifically, for each picture, it is determined if the picture is an I-frame (signifying the start of a GOP) or not. After determining the picture types, the Offset Metadata inserter 235 calculates the GOP length of each GOP in the video sequence. Then, when the Offset Metadata inserter 235 is parsing the MVC bitstream at a later stage, the Offset Metadata inserter 235 verifies that the GOP length of each GOP in the MVC stream is exactly the same as the corresponding GOP in the AVC stream. The GOPs must exactly line up between the AVC and the MVC streams, otherwise the resultant 3D MVC stream output from the Offset metadata inserter 235 will not be BLU-RAY compliant.

Regarding the use of the AVC stream for the verification, it is to be appreciated that such use is optional, although preferable, as the picture types could nonetheless be obtained from the MVC stream input to the Offset Metadata inserter 235. However, in such a case, complexity is increased, and the corresponding ability to provide the verification by checking the input AVC stream against the input MVC stream would be obviated.

The present principles provide a superior method and apparatus for Offset Metadata insertion workflow in that the Offset Metadata insertion is very fast when compared to the prior art methods and, also, do not need to perform the difficult task of video compression.

The Offset Metadata inserter begins by parsing its input parameters. These input parameters include: the input AVC (left view, or 2D) filename; the input MVC (right view) filename; the output MVC filename; and parameters which are used to create the Offset Metadata messages. These parameters are optional and include the following as examples: subtitling control filenames; constant offset values; initial removal delay value; frame rate value; and frame offset value.

After parsing the input parameters, the method and apparatus of the present principles read and parse any input subtitle control file. This is a special file which is produced to prepare language subtitles for disc authoring. This file includes some information about the video sequence (such as frame rate and length) as well as a list of the names and positions of each subtitle in the video. The position information includes both a 2D (x,y) coordinate as well as a depth value (disparity) which is used by the offset metadata inserter tool to create the offset metadata messages to embed in the bitstream.

The next step is to read and parse the high-level syntax of the input AVC bitstream. This is done in order to determine the GOP (Group Of Pictures) length of each GOP in the bitstream. This is required because the GOP length is one of the data values which is stored in the Offset Metadata message, and is not stored anywhere else in the bitstream.

The final step is to read and parse the input MVC bitstream while writing out the output MVC bitstream. There are several important tasks performed during this process. First, the high-level syntax of the MVC bitstream is verified against the structure of the previously-parsed AVC bitstream. They must match in certain ways to be compliant with the BLU-RAY specification, and if a mismatch is detected then an error will be reported. For example, some such ways where correspondence and/or matching should exist between the MVC input bitstream and the AVC input bitstream include GOP length, GOP structure (picture types), level, frame size, frame rate, aspect ratio, interlace type, and entropy coding mode. Secondly, most high-level data packets (called network abstraction layer (NAL) units) are read from the input MVC bitstream and passed directly on to the output MVC bitstream. However, at the correct places during the MVC bitstream parsing, an Offset Metadata message is created (based upon the input parameters and input data gathered from the subtitle control files) and inserted into the output MVC bitstream.

Turning to FIG. 3, an exemplary method for offset metadata insertion in multi-view coded video is indicated generally by the reference numeral 300. The method 300 includes a start block 305 that passes control to a function block 310. The function block 310 reads input parameters, and passes control to a decision block 315. The decision block 315 determines whether or not any subtitle control files are given. If so, then control is passed to a function block 320. Otherwise, control is passed to a function block 325. The function block 320 reads and parses the subtitle control files, and passes control to a function block 325. The function block 325 reads and parses the input AVC bitstream, obtains the GOP length of each GOP in the input AVC bitstream, and passes control to a function block 330. The function block 330 begins parsing the MVC input file, writes to the MVC output file, and passes control to a function block 335. The function block 335 reads one NAL unit, and passes control to a decision block 340. The decision block 340 determines whether or not there is a BLU-RAY compliancy error. If so, then control is passed to a function block 345. Otherwise, control is passed to a decision block 350. The function block 345 prints an error message, and passes control to an end block 399. The decision block 350 determines whether or not it is time to insert the Offset Metadata. If so, then control is passed to a function block 355. Otherwise, control is passed to a function block 365. The function block 355 creates an Offset Metadata message from input parameters, bitstream values, and data from the Subtitle control file, and passes control to a function block 360. The function block 360 inserts the Offset Metadata message in the output MVC bitstream, and returns control to the function block 335. The function block 365 writes this NAL unit into the output MVC bitstream, and passes control to a decision block 370. The decision block 370 determines whether or not there are any more NAL units remaining. If so, then control is returned to the function block 335. Otherwise, control is passed to the end block 399.

We note that one or more embodiments of the present principles involve a first input bitstream (e.g., an input AVC bitstream), a second input bitstream (e.g., an input MVC bitstream), and a third bitstream (e.g., an output MVC bitstream). We note that advantageously a re-encoding is not required to obtain the third bitstream (e.g., the output MVC bitstream). For example, in one embodiments, one or more Network Abstraction Layer (NAL) header units from the second bitstream (e.g., the input MVC stream) are modified to point to and/or include and/or otherwise relate to the disparity information or other information conveyed in an Offset Metadata message in a same or different packet. Here a packet would be considered an NAL unit, as per AVC and MVC. Such a message may be conveyed, for example, in the payload portion or the header portion of a packet, using any known methods for embedding data into a bitstream (including, but not limited to, mappings, tables, using existing syntax elements, etc., that are already present in the header to represent the embedded data, and so forth).

We note that in an embodiment, the Offset Metadata messages are inside their own NAL units, which is required by the BLU-RAY Standard. In an embodiment, the Offset Metadata messages are inside a special User Data Unregistered (SEI) message which is defined by the BLU-RAY Standard. The special User Data Unregistered (SEI) message is inside of an MVC Scalable Nesting SEI message, which is in its own NAL unit. Thus, in the preceding embodiment, the Offset Metadata information is always inside its own NAL units which are created by the Offset Metadata inserter. The NAL units from the second bitstream (e.g., the input MVC bitstream) are copied verbatim into the third bitstream (e.g., the output MVC bitstream).

However, there may be cases where it would be useful to modify the NAL units from the input bitstream(s) before writing them into the third bitstream (e.g., the output MVC bitstream). For example, in an embodiment, the Offset Metadata inserter can accept 2 independent AVC streams as input and write out a proper MVC stream as output. In such a case, the NAL units from the second (or the first) input bitstream can be modified in order to generate a syntactically correct MVC stream.

Regarding the Offset Metadata messages, such messages may also include other information as described herein and as readily contemplated by one of ordinary skill given the teachings of the present principles provided herein. For example, GOP lengths, and possibly other compression/decompression information (parameters, constraints, and/or so forth) as described herein and as readily contemplated given the teachings of the present principles provided herein, may be included in such Offset Metadata messages.

In an embodiment, one or more of different types of compression/decompression information such as GOP lengths and so forth may be extracted from the first bitstream (e.g., the input AVC bitstream) for simplicity sake and/or ease of extraction, format of underlying data or high layer means of conveying (e.g., network layer formatting, etc.), or any other reason such as one providing an advantage over extracting the same from the second bitstream (e.g., the input MVC bitstream) from which the underlying content is extracted and used to obtain the third bitstream (e.g., the output MVC stream). However, as readily understood by one of ordinary skill in this and related arts, such information as well as other compression/decompression information, may be determined directly from the second bitstream, while maintaining the spirit of the present principles. We capitalize on the different formatting between the first bitstream and the second bitstream to more readily extract the information such as the GOP lengths from the first bitstream. For example, we note that in the case of MVC versus AVC, it is easier to extract the GOP lengths than from AVC stream than the MVC stream because it is easier to extract the GOP lengths from an AVC stream than an MVC stream because picture types can be determined from the top-level data in an AVC stream (NAL unit types), while an MVC stream must be parsed further in order to determine picture types.

Again, we note that the preceding specific standards described in accordance with one or more exemplary embodiments of the present principles are, just as the embodiments, exemplary, in view of the teachings of the present principles provided herein. Hence, bitstreams encoded using other standards and/or recommendations may also be used in accordance with teachings of the present principles, while maintaining the spirit of the present principles.

A description will now be given of some of the many attendant advantages/features of the present invention, some of which have been mentioned above. For example, one advantage/feature is an apparatus having an offset metadata inserter for receiving a first bitstream compressed using a single-view based two-dimensional video compression scheme, a second bitstream compressed using a multi-view based two-dimensional video compression scheme, and disparity information, and outputting a third bitstream based on the first bitstream, the second bitstream, and the disparity information. Each of the first bitstream, the second bitstream, and the disparity information correspond to a same video sequence. The third bitstream includes group of pictures information extracted from the first bitstream and underlying content of the video sequence at least some of which is extracted from the second bitstream. The third bitstream has embedded therein one or more messages that specify the disparity information for use in overlaying information on an underlying content of the video sequence during a subsequent displaying of the overlaying information on the underlying content.

Another advantage/feature is the apparatus having the offset metadata inserter as described above, wherein a one-eye view of three-dimensional content is encoded in the third bitstream from the first bitstream, and another-eye view of the three-dimensional content is encoded in the third bitstream from the second bitstream.

Yet another advantage/feature is the apparatus having the offset metadata inserter as described above, wherein the first bitstream is parsed to determine a group of pictures length of each group of pictures in the first bitstream, the group of pictures length being specified in the one or more messages embedded in the third bitstream.

Still another advantage/feature is the apparatus having the offset metadata inserter as described above, wherein a verification process is performed to determine that a first output obtained from processing the first bitstream and a second output obtained from processing the second bitstream are combinable to form the third bitstream while maintaining a compliance with another video compression scheme.

A further advantage/feature is the apparatus having the offset metadata inserter wherein a verification process is performed as described above, wherein the other video compression scheme is the BLU-RAY two-dimensional standard or the BLU-RAY three-dimensional standard.

Moreover, another advantage/feature is the apparatus having the offset metadata inserter as described above, wherein at least some of the disparity information is derived from one or more of a subtitle control file and a constant offset value.

Further, another advantage/feature is the apparatus having the offset metadata inserter as described above, wherein the one or more messages embedded in the third bitstream include at least some non-disparity information derived from one or more of a subtitle control file, an initial removal delay value; a frame rate value, and a frame offset value.

Also, another advantage/feature is the apparatus having the offset metadata inserter as described above, wherein the single-view based two-dimensional video compression scheme is any one of the International Organization for Standardization/International Electrotechnical Commission Moving Picture Experts Group-4 Part 10 Advanced Video Coding Standard/International Telecommunication Union, Telecommunication Sector H.264 Recommendation, the International Organization for Standardization/International Electrotechnical Commission Moving Picture Experts Group-2 Standard, and the Society of Motion Picture and Television Engineers Video Codec-1 Standard.

Moreover, another advantage/feature is the apparatus having the offset metadata inserter wherein the single-view based two-dimensional video compression scheme is any one of the International Organization for Standardization/International Electrotechnical Commission Moving Picture Experts Group-4 Part 10 Advanced Video Coding Standard/International Telecommunication Union, Telecommunication Sector H.264 Recommendation, the International Organization for Standardization/International Electrotechnical Commission Moving Picture Experts Group-2 Standard, and the Society of Motion Picture and Television Engineers Video Codec-1 Standard as described above, wherein the multi-view based two-dimensional video compression scheme is the multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation

Additionally, another advantage/feature is the apparatus having the offset metadata inserter as described above, wherein the third bitstream includes a one-eye view that is backwards compatible with the single-view based two-dimensional video compression scheme.

Moreover, another advantage/feature is the apparatus having the offset metadata inserter as described above, wherein the overlaying information comprises at least one of a subtitle, a play icon, a stop icon, a forward icon, a reverse icon, and a menu.

Further, another advantage/feature is the apparatus having the offset metadata inserter as described above, wherein the offset metadata inserter is included in a video encoder.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. An apparatus, comprising:
an offset metadata inserter for receiving a first bitstream compressed using a single-view based two-dimensional video compression scheme, a second bitstream compressed using a multi-view based two-dimensional video compression scheme, and disparity information, and outputting a third bitstream based on the first bitstream, the second bitstream, and the disparity information, each of the first bitstream, the second bitstream, and the disparity information corresponding to a same video sequence, and
wherein the third bitstream includes group of pictures information extracted from the first bitstream and underlying content of the video sequence at least some of which is extracted from the second bitstream, the third bitstream having embedded therein one or more messages that specify the disparity information for use in overlaying information on the underlying content of the video sequence during a subsequent displaying of the overlaying information on the underlying content.

2. The apparatus of claim 1, wherein a one-eye view of three-dimensional content is encoded in the third bitstream from the first bitstream, and another-eye view of the three-dimensional content is encoded in the third bitstream from the second bitstream.

3. The apparatus of claim 1, wherein the first bitstream is parsed to determine a group of pictures length of each group of pictures in the first bitstream, the group of pictures length being specified in the one or more messages embedded in the third bitstream.

4. The apparatus of claim 1, wherein a verification process is performed to determine that a first output obtained from processing the first bitstream and a second output obtained from processing the second bitstream are combinable to form the third bitstream while maintaining a compliance with another based video compression scheme.

5. The apparatus of claim 4, wherein the other video compression scheme is the BLU-RAY two-dimensional standard or the BLU-RAY three-dimensional standard.

6. The apparatus of claim 1, wherein at least some of the disparity information is derived from one or more of a subtitle control file and a constant offset value.

7. The apparatus of claim 1, wherein the one or more messages embedded in the third bitstream comprise at least some non-disparity information derived from one or more of a subtitle control file, an initial removal delay value, a frame rate value, and a frame offset value.

8. The apparatus of claim 1, wherein the single-view based two-dimensional video compression scheme is any one of the International Organization for Standardization/International Electrotechnical Commission Moving Picture Experts Group-4 Part 10 Advanced Video Coding Standard/International Telecommunication Union, Telecommunication Sector H.264 Recommendation, the International Organization for Standardization/International Electrotechnical Commission Moving Picture Experts Group-2 Standard, and the Society of Motion Picture and Television Engineers Video Codec-1 Standard.

9. The apparatus of claim 8, wherein the multi-view based two-dimensional video compression scheme is the multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation.

10. The apparatus of claim 1, wherein the third bitstream comprises a one-eye view that is backwards compatible with the single-view based two-dimensional video compression scheme.

11. The apparatus of claim 1, wherein the overlaying information comprises at least one of a subtitle, a play icon, a stop icon, a forward icon, a reverse icon, and a menu.

12. The apparatus of claim 1, wherein the offset metadata inserter is comprised in a video encoder.

13. In an apparatus having incorporating a processor and a memory for storing instructions for performing method steps, a method comprising:
receiving a first bitstream compressed using a single-view based two-dimensional video compression scheme, a second bitstream compressed using a multi-view based two-dimensional video compression scheme, and disparity information; and
outputting a third bitstream based on the first bitstream, the second bitstream, and the disparity information, each of the first bitstream, the second bitstream, and the disparity information corresponding to a same video sequence,
wherein the third bitstream includes group of pictures information extracted from the first bitstream and underlying content of the video sequence at least some of which is extracted from the second bitstream, the third bitstream having embedded therein one or more messages that specify the disparity information for use in overlaying information on the underlying content of the video sequence during a subsequent displaying of the overlaying information on the underlying content.

14. The method of claim 13, wherein a one-eye view of three-dimensional content is encoded in the third bitstream from the first bitstream, and another-eye view of the three-dimensional content is encoded in the third bitstream from the second bitstream.

15. The method of claim 13, wherein the first bitstream is parsed to determine a group of pictures length of each group of pictures in the first bitstream, the group of pictures length being specified in the one or more messages embedded in the third bitstream.

16. The method of claim 13, wherein a verification process is performed to determine that a first output obtained from processing the first bitstream and a second output obtained from processing the second bitstream are combinable to form the third bitstream while maintaining a compliance with another video compression scheme.

17. The method of claim 16, wherein the other video compression scheme is the BLU-RAY two-dimensional standard or the BLU-RAY three-dimensional standard.

18. The method of claim 13, wherein at least some of the disparity information is derived from one or more of a subtitle control file and/or a constant offset value.

19. The method of claim 13, wherein the one or more messages embedded in the third bitstream comprise at least some non-disparity information derived from one or more of a subtitle control file, an initial removal delay value; a frame rate value, and a frame offset value.

20. The method of claim 13, wherein the apparatus is a video encoder.
